(19) United States
(12) Patent Application Publication
(10) Pub. No.: US 2005/0248184 A1
(43) Pub. Date: Nov. 10, 2005

(54) Pneumatically inflatable structural element for automotive vehicles

(75) Inventor: Marco Piffaretti, Rovio (CH)

Correspondence Address: GREENBLUM & BERNSTEIN, P.L.C., 1950 ROLAND CLARKE PLACE, RESTON, VA, 20191, US

(73) Assignee: Protoscar SA, Rovio (CH)

(21) Appl. No.: 11/124,263

(22) Filed: May 9, 2005

(30) Foreign Application Priority Data
May 10, 2004 (CH) 00818/04

(51) Int. Cl. B60R 19/20; B60R 21/34

(52) U.S. Cl. 296/187.03; 280/762; 293/107; 180/274

(57) ABSTRACT

A system including at least one inflatable portion structured and arranged to form an exterior surface of a body of a vehicle. The system is a pneumatically inflatable construction element. The at least one inflatable portion is structured and arranged to at least one of: protect the vehicle; protect against accidents; reduce wind turbulence of the vehicle; increase storage volume of the vehicle; improve safety of the vehicle; and/or cover the vehicle.

### CROSS-REFERENCE TO RELATED APPLICATIONS

The present application claims priority under 35 U.S.C. § 119 of Swiss Patent Application No. 00818/04, filed on May 10, 2004, the disclosure of which is expressly incorporated by reference herein in its entirety.

### BACKGROUND OF THE INVENTION

1. Field of the Invention

The present invention relates to a pneumatically inflatable structural element that can be installed on an exterior point of a body, for example an automotive vehicle.

2. Discussion of Background Information

In the construction of automotive vehicles, particularly passenger cars, it has become common use to equip the interior with pneumatically inflatable elements called airbags, attached in the passenger compartment and also on the inside of the doors. Such airbags have a specific function, that is to inflate rapidly, almost explosively, in case of a car crash against an obstacle, thus providing a sort of protective mattress for the person or persons inside the vehicle. Airbags are one-way, that is they can only inflate once and must be replaced after functioning. Indeed, their reaction speed is essential, since from it depends the efficacy of the protection they may offer. The airbag inflation can thus only be triggered off by “bursting” a container of gas under shut-in pressure.

This invention comes into line with nowadays increasingly wide use of inflatable elements, such as inflatable air mattresses and cushions for various uses to support body parts, etc. There is knowledge of specific realizations, such as an aircraft with inflatable wings or even an airtight zipper, thanks to the fact that it can be pneumatically pressured.

The present invention looks to encompass knowledge acquired in diversified sectors of inflatable products and apply that knowledge to improve the safety, comfort and economic character of automotive vehicles, in particular, passenger cars. The instant invention looks to provide manufacturers of pneumatically inflatable construction elements with products relating to inflatable structural elements that can be installed on an exterior point of a body, for example a automotive vehicle. For example, the present invention looks to improve vehicle safety in relation to the other road users in case of collision, e.g., pedestrians, persons or cyclists, etc., that may be slightly protected from being injured from other road users. Further, the present invention may provide an increased protection to bodies, such as vehicles, from damage from other road users, for example bumpers, doors, etc. The present invention may improve aerodynamic characteristics and road handling of the vehicle, as well as improving the vehicle grip under various operating conditions, e.g., speed, road conditions, etc. Further, the instant invention may improve comfort and the usage possibilities for the user of the vehicle by working on sectors such as unroofing it or varying the size or shape of the trunk, etc. The present invention may improve the running conditions of the vehicle, e.g., the cooling of the engine.

### SUMMARY OF THE INVENTION

The present invention is a pneumatically inflatable construction element (or system) that may be installed on an exterior point of a body, for example a vehicle. The pneumatically inflatable construction element may or may not have a direct protective function for the users of the body, e.g., vehicle, since this protective function is fulfilled by known airbag systems. However the present invention performs one or more functions which may provide the above mentioned advantages. For example, the pneumatically inflatable construction element can increase protection to bodies, such as vehicles, from damage from other road users. Further, the element may improve aerodynamic characteristics and road handling of the vehicle, e.g., improve vehicle grip while adapting to the specific road conditions. Further still, improve comfort and usage for the user of the vehicle by working on sectors, or improving the running conditions of the vehicle, e.g. the cooling of the engine. Each one of these above elements may have a different location on the exterior of the body and fulfill a specific function.

The pneumatically inflatable construction elements can be inflated by the user manually via a pump (or compressor) or, alternatively, automatically, depending on the need of the element itself. The inflatable element may be inflated manually by the user, for instance to open the sun roof of a vehicle (if the element is incorporated into an openable roof), or the element can be automatically inflated via a specific sensor. Thus, the element may provide an alternate usefulness, for instance, if road conditions require to modify a specific aerodynamic characteristic of the vehicle on which the element may be able to influence. The pneumatically inflatable element may be inflated and/or deflated slowly, such as in separate and different stages, thus not requiring a speed inflation feature such as in a conventional airbag system. The relatively slow inflation permits the elements use to include the operation of a small pump, compressor or for limited uses such as a hand pump. Further, not all the uses of the inventive inflatable element are foreseen for activation during the vehicle run. The element may be inflated either when the body, e.g., vehicle is stationary or moving, depending on the specific operation or use of the element.

### BRIEF DESCRIPTION OF THE DRAWINGS

The present invention is further described in the detailed description which follows, in which like reference numerals represent similar parts throughout the several views of the drawings, and wherein:

FIG. 1 illustrates a view of an exemplary embodiment of an inventive inflatable construction element, presented as an openable roof of the vehicle;

FIG. 2 illustrates the inflatable element of FIG. 1 shown during the various phases of the elements’ inflation;

FIG. 3 illustrates a view of an exemplary embodiment of an inflatable element presented as a roof rack for a vehicle (torpedo) in an inflated position;

FIG. 4 illustrates the element of FIG. 3 at rest, that is deflated;

FIG. 5a-5c illustrate a section of the inflated element of FIG. 1 and FIG. 2 in three different phases, that is on top of the vehicle, at rest according to FIG. 4, the element is positioned below in working position according to FIG. 3, and the element is positioned in between in an intermediate position during the inflation;

FIG. 6 illustrates a view of an exemplary embodiment of an inflatable element as rear spoiler of the vehicle;

FIG. 7 illustrates a view of an exemplary embodiment of a vehicle provided with two types of inflatable construction elements according to the invention, that is a front spoiler and a side spoiler (called in automotive language “miniskirt”);

FIG. 8 illustrates a view of an exemplary embodiment of an inflatable element constituting a curtain which reduces the space between the wheel of the vehicle and its body;

FIG. 9 illustrates a view of an exemplary embodiment of an inflatable element which constitutes the covering of the front hood of the vehicle;

FIG. 10 illustrates a view of an exemplary embodiment of an inflatable element as a protection for the vertical edge of the vehicle door;

FIG. 11 illustrates a view of an exemplary embodiment of an inflatable element as a side protection of the body between the two wheels on the same side of the vehicle;

FIG. 12 illustrates a view of an exemplary embodiment of an inflatable element which constitutes a part of a front bumper of the vehicle;

FIG. 13 illustrates a view of an exemplary embodiment of an inflatable element which constitutes a part of the grille of the vehicle in an open position, in order to permit the circulation of additional cooling air;

FIG. 14 illustrates the element of FIG. 13 in a closed position, in order to permit the circulation of less cooling air;

FIG. 15 illustrates a view of an exemplary embodiment of an inflatable element which constitutes a rear trunk of the vehicle, such as to transform a limousine into a combi;

FIG. 16 illustrates the layout of a control unit of the compressor to operate the pneumatically inflatable construction elements according to the invention.

### DETAILED DESCRIPTION OF THE PRESENT INVENTION

The particulars shown herein are by way of example and in all of the drawings the inventive inflatable elements shown have been cross sectioned in order to facilitate their identification. Practically, the same type of car has been used for all drawings, however the invention may evidently be applied to any type of vehicle, e.g., limousine (sedan; coupe), combi (or wagon), pick-up truck, van or truck. In particular, by selecting the type of use and/or specific purpose for the inflatable element (or elements) would determine a type of body, e.g., vehicle, for the element to be applied, according to the invention.

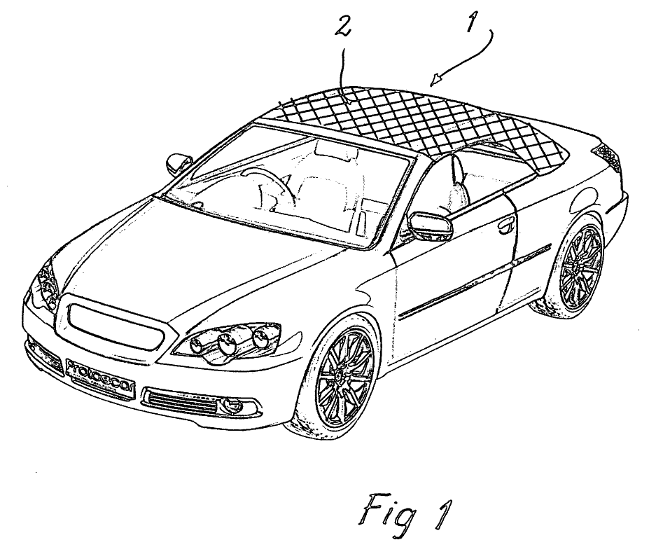

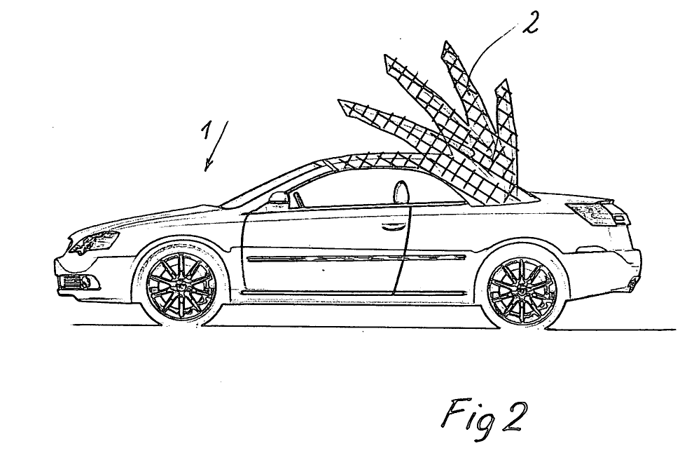

FIG. 1 shows an embodiment according to the invention of a vehicle 1 having a pneumatically inflatable construction element (or system) in the shape of an inflatable openable roof 2, which shows the roof in a closed position. FIG. 2 shows another embodiment of the element in four different closing stages.

FIG. 2 shows the inflatable roof 2 in an open position contained in a compartment behind the rear seat of the vehicle, which similar to known normal openable roofs of a cabriolet or convertable. The inflatable roof 2 may be composed of more than one pneumatic chamber and, if necessary, is provided with the necessary lateral sideway leverage which allows for a gradual opening upward in order not to disturb the persons sitting in the vehicle. In particular, gears may be arranged with the use of pneumatic pistons which lift (and lower) the roof 2 leverage, and the use and arrangement of such gears is well with the skill of those in the art and therefore is not further described herewith. The control of the pump that sets on the chambers of the roof may be operated manually by the driver, e.g., by activating an appropriate switch. The roof can be activated when the car is at standstill or in motion, since the configuration of the pneumatic chambers can be configured to withstand aerodynamic wind pressure when the car is moving due to the air pressure within the pneumatic chambers.

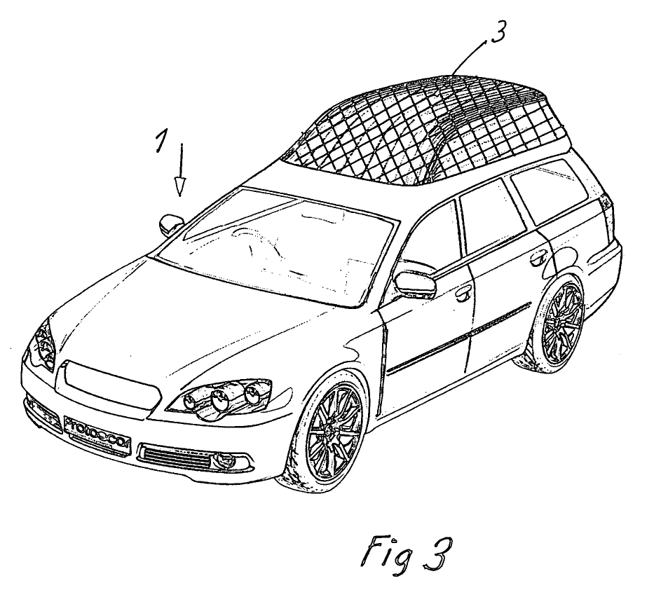

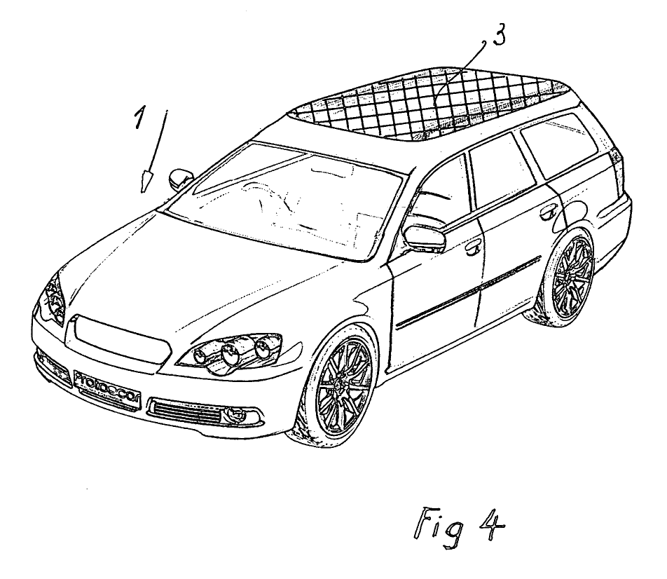

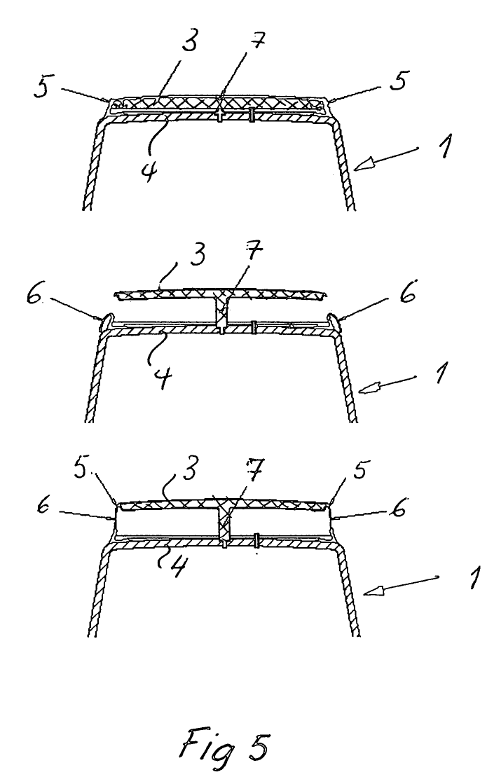

FIGS. 3, 4 and 5 show an alternative use of the present invention. In this case, the pneumatically inflatable construction element may have the shape of a roof rack 3 or element (also called “torpedo” in automotive language) that is positioned on the vehicle. FIG. 3 shows the roof rack 3 or element in a working position, that is “inflated”, while in Figure shows the roof rack in a deflated or flat position which adheres to the roof of the vehicle. FIG. 5 shows the construction of the inflatable roof rack 3, in a resting position. In particular, the resting position arranges the roof rack so as to adhere to the roof 4 of the vehicle under a minimum pressure, thus stretching the roof rack 3 slightly. Further, on both sides of roof rack 3 there is half a zipper 5 that can be operated manually. A strip of flexible material 6 (see FIG. 5b), fitted with the other half of the zipper, can be fastened on both sides of roof 4 of the vehicle and/or on all four sides of the roof rack 3). Further, the top part of the flexible strip 6 (e.g. made of fabric) can be fixed to the edges of the roof rack 3 (see FIG. 5c), so as to close the space in which, the objects can be transported (e.g. skis, snowboard, etc.). The inflatable element 3 can be fitted with a lifting device 7, e.g., an inflatable chamber or a mechanical element and has the function of pushing the roof rack 3 upward when placed under pressure.

FIG. 5 shows examples of the construction details of the zipper 5, strip 6 and lifting device 7. Further, it is understood that the above examples are presented as only an example and other ways of construction are possible as understood by any craftsman. Also the activation mode of the inflatable element 3 forming the roof rack 3 can be implemented manually, e.g., a simple bicycle pump or by an automatic arrangement. The roof rack 3 is an element that can be inflated at any moment and, preferably when the car is at standstill.

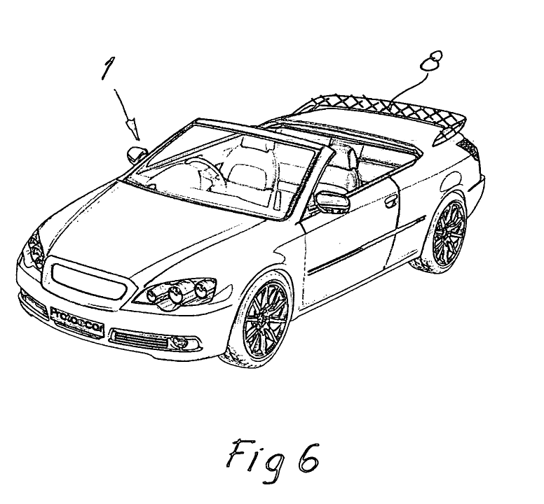

FIG. 6 shows another feature of the invention, the pneumatically inflatable element 3 can be presented as a rear spoiler 8, e.g., a stabilizer for the vehicle 1. The rear spoiler 8 can be shaped and positioned to influence the road handling of the vehicle at high speeds by varying the air pressure in the rear spoiler 8. Thus, the pressurization of the inflatable element 3 can be inflated by an automatic arrangement. For example, a control unit can be fitted with car speed sensors and with an air pressure gauge to automatically inflate the pneumatic spoiler 8, so as to adapt the inflation pressure to the vehicle speed, thus suitably adapting the aerodynamic effect of spoiler 8. At low car speed, the spoiler 8 may be completely deflated or arranged into the body of the car.

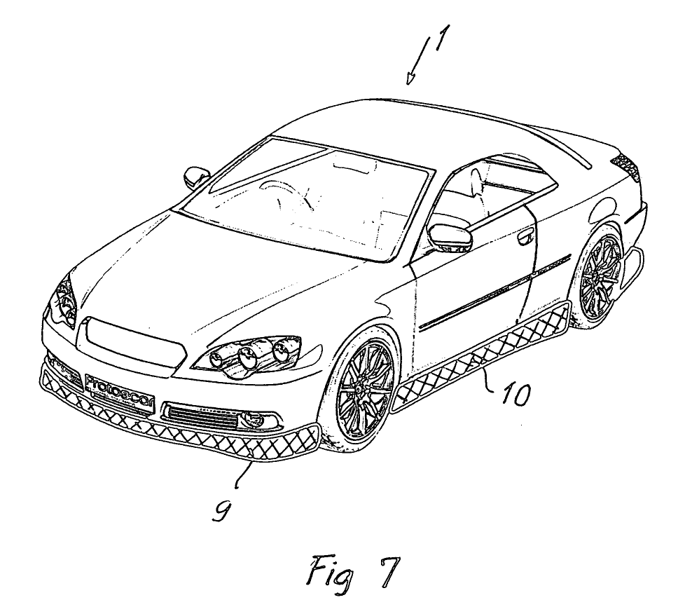

FIG. 7 shows another feature of the invention, the pneumatically inflatable element 3 can be presented as a front spoiler 9 of vehicle 1 which, when inflated, e.g., automatically reduces the distance between road and vehicle. The front spoiler 9 may also include an inflatable chamber that is tubular shape which can be fixed on the interior part of the grille of vehicle 1.

According to another embodiment of the invention, as viewed in FIG. 7, the pneumatically inflatable element 3 can be a side spoiler 10 (called “miniskirt” in automotive language) when inflated. The side spoiler may be inflated (automatically reducing the distance between road and vehicle) at the same time as front spoiler 9 is inflated, It is well known that the turbulence under the vehicle, can be reduced by lowering of the complete body through the suspensions of the car, which can be a very effective way to improve the road handling on superhighways as well as to reduce energy consumption. The inflated spoilers (rear 8, front 9 and side 10) of the present invention, may be used either individually or all together so as achieve the results of varying the height of the car.

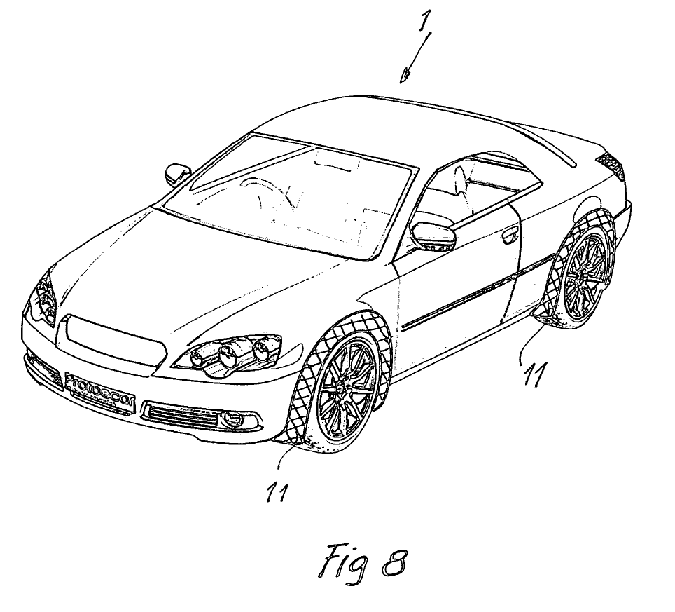

FIG. 8 shows another embodiment of the invention, an inflatable curtain 11 which may eliminate turbulence that develops at high speed between the wheel and the engine. The pneumatically inflatable element which can be presented as an inflatable curtain 11, reduces the space mentioned above, thus preventing, respectively reducing, the development of turbulence and improving running conditions and gasoline consumption of the vehicle.

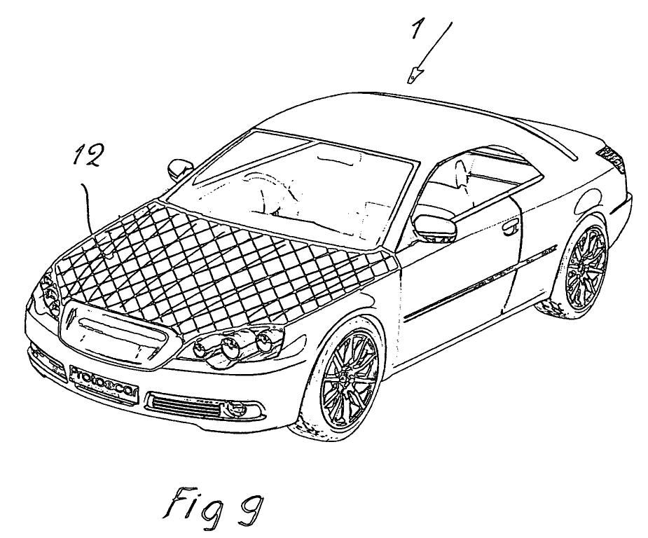

FIG. 9 shows another embodiment of the invention, the pneumatically inflatable element that can be presented as a covering of a front hood 12 of a car when inflated, thus providing an elastic impact surface. In particular, the front hood 12 may provide a safety feature in case of an accident, if the car hits a pedestrian or a cyclist while in motion. It is well known that in such a case the hood of the vehicle represents a very dangerous impact surface for both the pedestrian and driver of the car. The present invention allows an essential improvement for the above situation by providing for the pneumatically inflatable element as a covering of front hood 12 that forms, after the inflation, an elastic impact surface. In practice, the inflatable hood may be executed as a self-supporting structure with multiple air tubes if necessary, to increase the rigidity, as well as including diagonal support stiffeners arranged for the engine compartment. The inflatable hood may offer other specific characteristics: such as thermal, sound insulation, and pressure control in the individual chambers, etc.

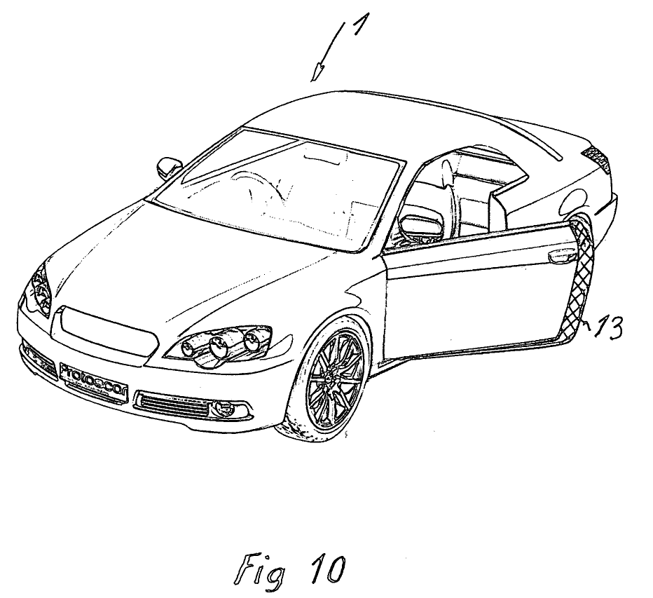

FIG. 10 shows another embodiment of the invention, the pneumatically inflatable element forms a protection for the vertical edge of the door 13. The inflatable element can be deflated and hidden behind the door, invisible from the outside and perhaps sucked by a suitable hollow. As an example, the inflatable element may automatically inflate when the door is opened manually and deflate when the door is closed again. The inflatable element can eliminate damage to the owner's vehicle, as well as to nearby cars or objects when the car door is opened and/or closed.

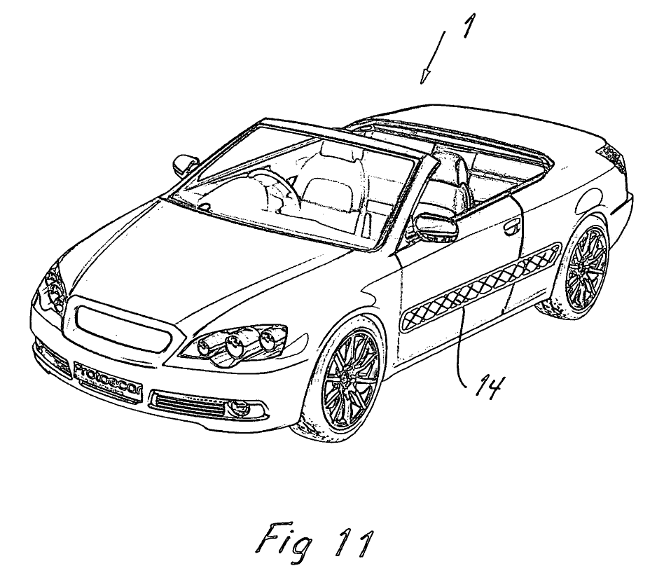

FIG. 11 shows another embodiment of the invention, a pneumatically inflatable element as a lateral protection 14 for the body or car. The lateral protection 14 can be considered similar to the above mentioned vertical edge protection for the door, in terms of preventing damage to the body or car.

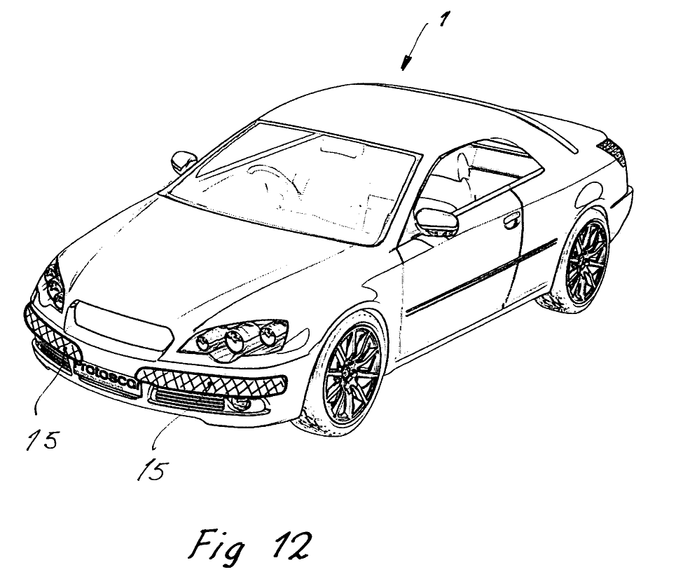

FIG. 12 shows another embodiment of the invention, the pneumatically inflatable element as a part 15 of the body or front bumper of the automotive vehicle. The part 15 may reduce or eliminate parking damages that may occur during parking of the car. Also these protections can be manually operated by the user if need be or can snap automatically following a signal by a sensor that points out the excessive proximity to an obstacle.

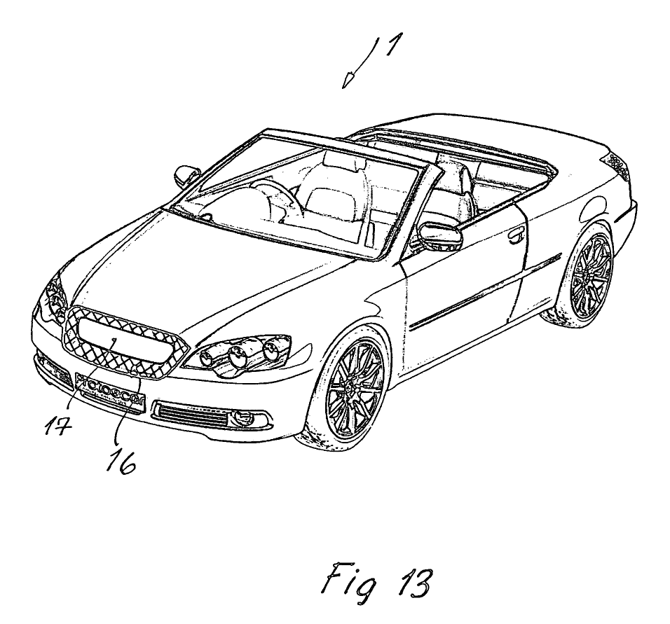

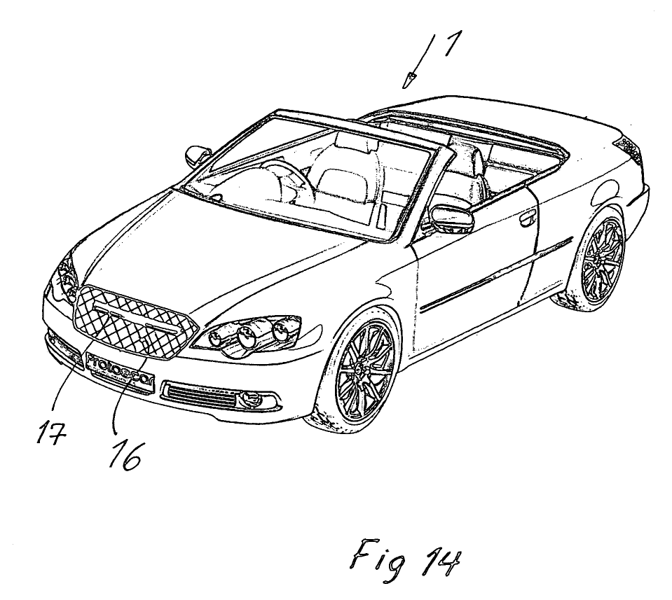

FIGS. 13 and 14 shows another embodiment of the invention, which can provide the regulation of cooling air of the radiator depending on the outside air temperature and on the power supplied by the engine. The pneumatically inflatable element can be a engine grille 16, or ventilating grille, which is able to close and/or open the opening for the engine cooling air inlet 17 of the radiator, using an inflation device.

FIG. 13 shows the engine grille 16 partially inflated allowing for a large amount of air to enter through the engine grille 16 to provide cooling air to the engine radiator, for example during very hot environmental conditions.

FIG. 14 shows the engine grille 16 fully inflated, which allows for a minimal amount of air to enter through the engine grille 16 to the engine radiator, for example during winter conditions. Further, as an example control mechanisms may be included for the inflatable grille 16, which may include (but is not limited to) an outside air temperature sensor, engine temperature sensor, and control of compressor operations of the air for inflation. Further, the construction of the inflatable grille 16 may include one or more air tubes which may be located in various locations in the grille 16.

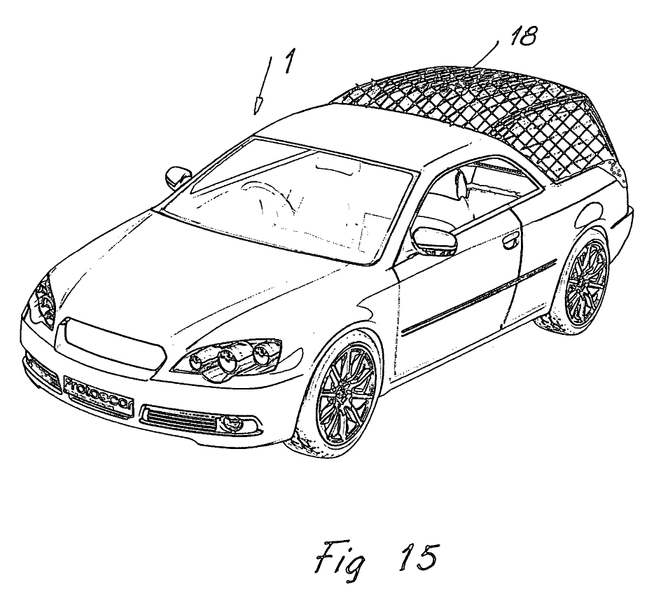

FIG. 15 shows another embodiment of the invention, that may provide for the transformation of a limousine into a combi type car (or wagon). The pneumatically inflatable element constitutes a rear trunk 18 which permits to increase considerably the volume of the standard trunk of a limousine. In a deflated condition, the inflatable element 18 can be located in the trunk lid of the car. The inflation of inflatable element 18 can then occur by opening the trunk lid. Various solutions are possible so as to achieve this basic concept, either with the appropriate leverages or pneumatic pistons. The material of the pneumatically inflatable element according to the invention, may include, but is not limited to, polyvinyl chloride (PVC) reinforced with fibers resistant to ultraviolet rays and temperatures between −60° and +80°. Further, the characteristics of the material may include resistance to acids, flexible material as well as a material having anticrease properties. The craftsman will have no difficulty in finding flexible but not elastic materials which fulfill these conditions, along with the vast experience acquired in this matter similar to this invention and mentioned in the introduction.

According to another feature of the invention, the pneumatically inflatable construction elements mentioned above can be activated by inflation devices that can be of different types, e.g., manual, automatic, or operated by suitable sensors that react to specific predetermined outside conditions.

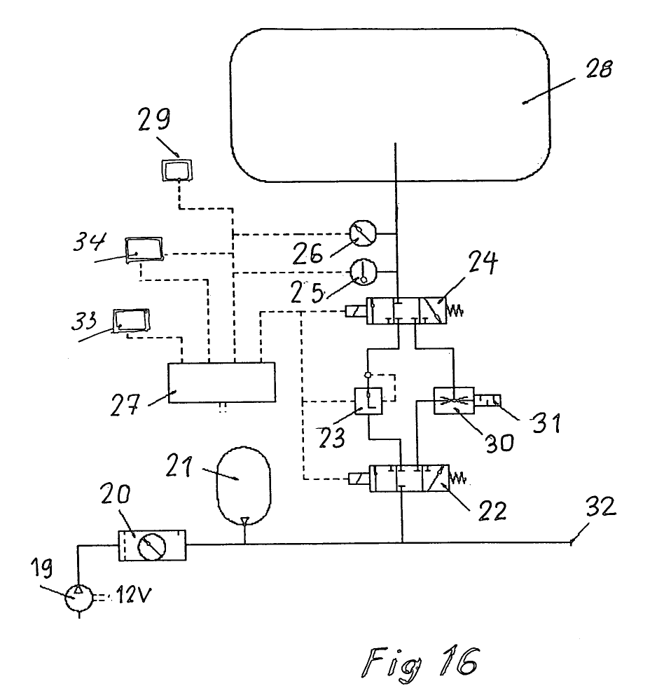

FIG. 16 shows an exemplary control circuit adapted to the inflatable element which may be in communication with an energy source. The control unit may include a compressor 19 powered with 12 volt and can be based on an SPS command as well as of various sensors which permit an automatic operation. The above components may provide for the inflation of the inflatable element 28 as well as for the inflation of other various components. The above components may be composed of a flexible material such as textile reinforced PVC.

According to another feature of the invention, the inflation process to inflate the pneumatically inflatable construction element can be started, for example, by an operating switch or following an automatic control via sensors. The inflation process may include the following steps: a compressor 19 generates compressed air fed through an air preparation unit 20; past an air storage 21, through a three-way valve 22, into an automatically controlled pressure reduction unit 23, and then through another three-way valve 24. A thermometer 25 and a pressure gauge 26 may be incorporated after the last three-way valve 24, in order to allow the control device 27 to supervise the complete the filling process of the inflatable element 28. The control device 27 supervises automatically and intermittently, through thermometer 25 and pressure gauge 26, the inflatable element 28. Depending on the use, other specific sensors may be incorporated to assist in the supervision and control of the inflatable element. The control device may be activated, for example, by a manual switch 33 or an automatic switch 34. The deflation process can be started manually or automatically through sensors 29. The deflation process may include the steps of air entering the three-way valve 22, and the compressed air of the compressor 19 being forwarded to an air suction lance 30. A suction is formed, sucking air via the three-way valve 24, from the pneumatically inflatable component 28 through a muffler 31 which forwards it into the atmosphere. At point 32, the pneumatic units 22, 23, 24, 25, 26, 30 and 31 can be joint, thus allowing a simultaneous filling and emptying of two inflatable elements according to the present invention.

The advantages of the invention are wide-ranging depending on the type of problem to be solved. The pneumatically inflatable construction elements, can provide car safety for occupants in the car, as well as for other users of the roadways. Further, the inflatable elements can provide protection to the cars and other cars on the road. Further still, the inflatable elements can provide convenience, comfort, reduced gasoline consumption at an inexpensive cost.

1-18. (canceled)

19. A system comprising:
at least one inflatable portion structured and arranged to form an exterior surface of a body of a vehicle.

20. The system in accordance with claim 19,
wherein the at least one inflatable portion is structured and arranged to at least one of: protect the vehicle; protect against accidents; reduce wind turbulence of the vehicle; increase storage volume of the vehicle; improve safety of the vehicle; and/or cover the vehicle.

21. The system in accordance with claim 19,
further comprising a pneumatically inflatable construction element.

22. The system in accordance with claim 19,
further comprising a pump activatable by one of an electric motor and a hand device.

23. The system in accordance with claim 21,
wherein the electric motor is manually activatable by a user to start and stop.

24. The system in accordance with claim 19,
further comprising a pump that is mechanically activated by at least one traction motor.

25. The system in accordance with claim 21,
further comprises at least one sensor arranged to automatically activate one of the motor and the pump.

26. The system in accordance with claim 19,
wherein the at least one inflatable portion is composed of at least one of a plastic material, a plastic material reinforced with fibers, and a material resistant to ultraviolet rays, and
wherein the material of the at least one inflatable portion is structured to withstand temperatures between −60° F. and +80° F. and/or at least one acid and/or exhibit anticrease properties.

27. The system in accordance with claim 19,
wherein the at least one inflatable portion, when inflated, forms a roof of the vehicle, so as to cover an inside portion of the vehicle.

28. The system in accordance with claim 19,
wherein the at least one inflatable portion, when inflated, forms a baggage rack arranged on a roof of the vehicle and, when deflated, forms a closed space,
wherein the at least one inflatable portion is defined by an inflatable covering which raises from the roof of the vehicle by inflation, and the inflatable covering includes at least one lateral covering component, and
wherein the at least one lateral covering component is fastened on at least two sides of the roof of the vehicle and/or fastened on at least two sides of a roof rack.

29. The system in accordance with claim 19,
wherein the at least one inflatable portion, when inflated, forms a rear spoiler of the vehicle and, when deflated, forms a closed space.

30. The system in accordance with claim 19,
wherein the at least one inflatable portion, when inflated, forms a front spoiler of the vehicle, so as to reduce a distance between a surface of a road and the vehicle.

31. The system in accordance with claim 19,
wherein the at least one inflatable portion, when inflated, forms a lateral spoiler or miniskirt of the vehicle, so as to reduce a distance between a surface of a road and the vehicle.

32. The system in accordance with claim 19,
wherein the at least one inflatable portion is defined by an inflatable curtain, such that, when inflated, is arranged to reduce a space between a wheel and a body of the vehicle.

33. The system in accordance with claim 19,
wherein the at least one inflatable portion, when inflated, forms a covering for a front hood of the vehicle and forms an elastic impact surface.

34. The system in accordance with claim 19,
wherein the at least one inflatable portion, when inflated, forms a protection for at least a portion of a vertical edge of a door of the vehicle.

35. The system in accordance with claim 19,
wherein the at least one inflatable portion, when inflated, forms a lateral protection between at least two wheels on a same side of the exterior of the vehicle.

36. The system in accordance with claim 19,
wherein the at least one inflatable portion forms at least a portion of a bumper of the vehicle.

37. The system in accordance with claim 19,
wherein the at least one inflatable portion forms at least a portion of a grille of the vehicle, so as to at least partially regulate an air inlet for engine cooling by a degree of inflation.

38. The system in accordance with claim 19,
wherein the at least one inflatable portion, when inflated, forms is an inflatable rear trunk, and transforms the vehicle into a combi vehicle.

39. The system in accordance with claim 19,
wherein the at least one inflatable portion has at least one of at least one lifting device and a mechanical element for pushing a roof rack upward when placed under a pressure on a roof of the vehicle.
